(19) United States
(12) Patent Application Publication
(10) Pub. No.: US 2018/0111301 A1
(43) Pub. Date: Apr. 26, 2018

(54) DEVICE FOR MAKING FOAM PIPES AND METHOD FOR MAKING FOAM PIPES

(71) Applicant: TENG-PU LIN, TAICHUNG CITY 40869 (TW)

(72) Inventor: TENG-PU LIN, TAICHUNG CITY 40869 (TW)

(21) Appl. No.: 15/298,436

(22) Filed: Oct. 20, 2016

(51) Int. Cl. B29C 47/00; B29C 44/02; B29C 47/88

(52) U.S. Cl. CPC B29C 47/0042; B29C 44/02; B29K 2105/041; B29C 47/882; B29C 47/0023

(57) ABSTRACT

A device for making foam pipes and a method for making the foam pipes includes the use of critical micro foaming injection molding. The foaming agent and the foaming material are mixed and controlled under specific temperature to obtain micro bubbles in the wall of the foam pipes which need less material when compared with PVC pipes of same specification such that manufacturing cost is reduced.

### BACKGROUND OF THE INVENTION

### 1. Fields of the Invention

The present invention relates to a device for making foam pipes and a method for making the foam pipes to save manufacturing cost.

### 2. Descriptions of Related Art

The conventional pipes are made by Poly Vinyl Chloride (PVC) and commonly known as PVC pipes whose hardness can be changed by different ways of manufacturing to obtain hard PVC pipes and normal PVC pipes. The normal PVC pipes can be bent to a desired shaped so as to be used in different situations. The hard PVC pipes are used for electric engineering and sewer pipes. The PVC pipes are light in weight and durable to corrosion, alkaline and acid so that they are suitable in chemical related fields.

The price for the PVC pipes drops dramatically due to competition. The market price is close to the raw material and there is limited differences between different brands of PVC pipes.

The present invention intends to provide a device for making foam pipes and a method for making the foam pipes to save manufacturing cost.

### SUMMARY OF THE INVENTION

The present invention relates to a device for making foam pipes, and comprises a micro foam extruding unit which has a base, an extruding pipe, a control portion, an input member and a mold head. The extruding pipe and the control portion are connected to the base. The input member and the mold head are located corresponding to two ends of the extruding pipe. The extruding pipe has a pre-heating section and a foaming section which is connected to the pre-heating section. Multiple heating members are axially and alternatively connected to outside of each of the pre-heating section and the foaming section so as to transfer heat to the extruding pipe to pre-heat foaming material and to reach melting temperature and foaming temperature of the foaming material. Foaming agent is spread and solved in the foaming material that is melted. The melted foaming material is extruded from the mold head to expand micro bubbles to form a foam pipe with micro bubbles. The heating members are controlled by control buttons. Multiple temperature detectors are connected to the mold head, the pre-heating section and the foaming section to respectively transfer temperature signals to temperature gauges on the control portion. The temperature of the foaming section is higher than that of the mold head.

A cooling unit has a cooling tank which includes an input hole and an output hole in two ends thereof. The foam pipe extends through the input hole and the output hole. The cooling unit has multiple cooling pipes which extend into the cooling tank. The cooling pipes transfers cooling liquid and contact the foam pipe to reduce temperature of the foaming pipe.

A roller tracker has at least one top roller and at least one bottom roller to press the foam pipe and guide the foam pipe. A scrolling unit has a rotary member to scroll the foam pipe.

Preferably, the temperature of the foaming section is higher than that of the pre-heating section.

Preferably, multiple blowing members are alternatively located to the base and electrically connected to the control buttons. The blowing members blow air toward the foaming section.

Preferably, the at least one bottom roller of the roller tracker includes a recess defined in the outer periphery thereof so as to roll the foam pipe.

The present invention further provides a method for making the foam pipes, and the method comprises:

an extruding step: foaming material and foaming agent being put in an input member of a micro foam extruding unit and being extruded from an extruding pipe, the foaming material being heated and melted in the extruding pipe and a mold head that is connected to the extruding pipe, the foaming agent being resolved in the melted foaming material, a semi-finished foam pipe with micro bubbles being extruded from the mold head, the foaming material being heated in the extruding pipe and receiving pre-heating temperature, foaming temperature and mold head temperature in sequence, a temperature of the foaming temperature being higher than or equal to that of the mold head temperature;

a cooling and forming step: the semi-finished foam pipe being sent into a cooling unit and in contact with liquid to be cooled down;

a roller tracking step: a periphery of the cooled semi-finished foam pipe being tracked by a top roller and a bottom roller of a roller tracker, and

a scrolling step: the foam pipe tracked by the top roller and the bottom roller being rolled by a scrolling unit.

Preferably, the foaming material is Poly Vinyl Chloride (PVC), Ethylene Vinyl Acetate (EVA), Polyethylene (PE) or Polyurethane (PU). The foaming agent is Azodicarbonamide (ADCA), C₂H₄O₂N₄ (AC foaming agent), OBSH foaming agent, and DPT foaming agent. Generally, 0.1 to 0.6 grains of the foaming agent is used for 1 kilogram of foaming material.

Preferably, the temperature of the foaming temperature is higher than that of the pre-heating temperature.

The primary object of the present invention is to provide a device for making foam pipes and a method for making the foam pipes by the use of critical micro foaming injection molding. The foaming agent and the foaming material are mixed and controlled under specific temperature to obtain micro bubbles in the wall of the foam pipes which need less material when compared with PVC pipes of same specification such that manufacturing cost is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the device for making the foam pipes of the present invention;

FIG. 2 is an enlarged view to show the micro foam extruding unit of the present invention;

FIG. 3 is an enlarged view to show the cooling unit of the present invention; and

FIG. 4 shows the steps of the method of the present invention.

### DETAILED DESCRIPTION OF THE PREFERRED EMBODIMENT

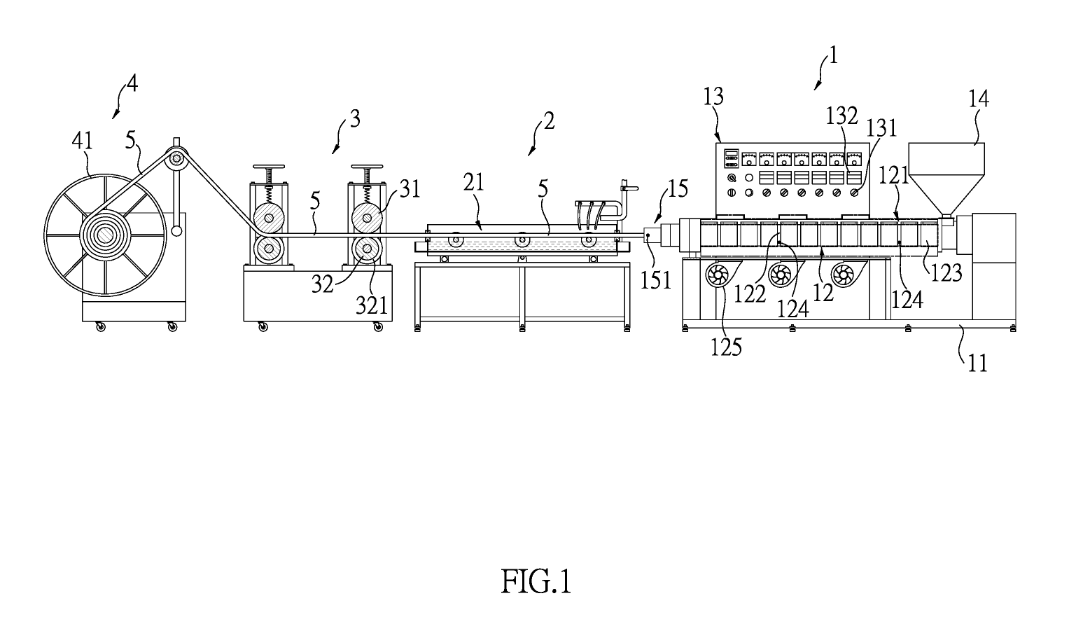

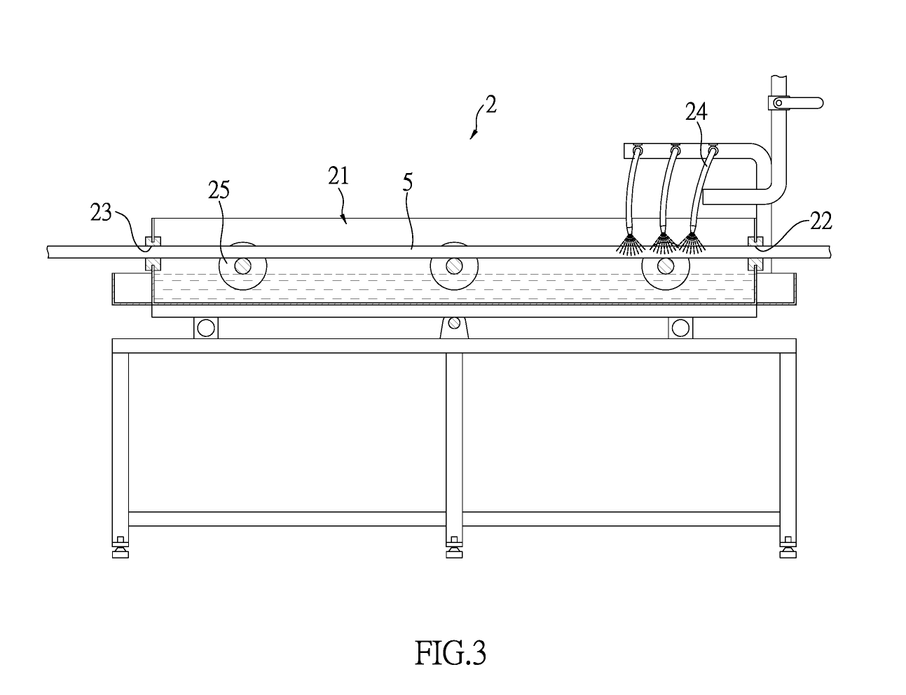

Referring to FIGS. 1 to 3, the device for making foam pipes of the present invention comprises a micro foam extruding unit 1 has a base 11, an extruding pipe 12, a control portion 13, an input member 14 and a mold head 15. The extruding pipe 12 and the control portion 13 are connected to the base 11, and the input member 14 and the mold head 15 are located corresponding to two ends of the extruding pipe 12. The extruding pipe 12 has a pre-heating section 121 and a foaming section 122 which is connected to the pre-heating section 121. Multiple heating members 123 are axially and alternatively connected to the outside of each of the pre-heating section 121 and the foaming section 122 so as to transfer heat to the extruding pipe 12 to pre-heat foaming material and to reach melting temperature and foaming temperature of the foaming material. The foaming agent is spread and solved in foaming material that is melted. The melted foaming material is extruded from the mold head 15 to expand micro bubbles to form a foam pipe 5 with micro bubbles. The heating members 123 are controlled by control buttons 131. Multiple temperature detectors 124, 151 are connected to the mold head 15, the pre-heating section 121 and the foaming section 122 to respectively transfer temperature signals to temperature gauges 132 on the control portion 13. When the operators operate the control buttons 131, the heating members 123 increase the temperature of the extruding pipe 12 so that the temperature of the foaming section 122 is higher than that of the mold head 15.

A cooling unit 2 has a cooling tank 21 which includes an input hole 22 and an output hole 23 in two ends thereof. The foam pipe 5 extends through the input hole 22 and the output hole 23 so as to enter into the cooling tank 21 and leave from the cooling tank 21. The cooling unit 2 has multiple cooling pipes 24 which extend into the cooling tank 21, the cooling pipes 24 transferring cooling liquid and contact the foam pipe 5 to reduce temperature of the foaming pipe 5.

A roller tracker 3 has at least one top roller 31 and at least one bottom roller 32 to press the outer periphery of the foam pipe 5 and guide the foam pipe 5. In this embodiment, there are two top rollers 31 and two bottom rollers 32. A scrolling unit 4 has a rotary member 41 to scroll the foam pipe 5.

When in operation, the foaming material and the foaming agent are introduced into the extruding pipe 12 via the input member 14, The heating members 121 around the extruding pipe 12 transfer heat to the extruding pipe 12 to melt the foaming material which becomes liquid-like and flows. The foaming agent is resolved in the melted foaming material to expand micro bubbles, so that when the foam pipe 5 is extruded out from the mold head 15, the foam pipe 5 includes multiple micro bubbles. The foam pipe 5 is then cooled down by the liquid of the cooling unit 2. The top and bottom rollers 31, 32 move the foam pipe 5 to be rolled by the rotary member 41 of the scrolling unit 4.

The foaming agent, under control of specific temperature and pressure, is resolved in the melted foaming material to expand micro bubbles, so that when the foam pipe 5 is extruded out from the mold head 15, the foam pipe 5 includes even micro bubbles. The foam pipe 5 involves less material and lower manufacturing cost when compared with the conventional PVC pipes. The hardness of the foam pipes 5 is easily adjusted by adjustment of the micro bubbles.

The blowing members 125 are alternatively located to the base 11 and electrically connected to the control buttons 131. The blowing members 125 blow air toward the foaming section 122 (below the extruding pipe 12) so that the temperature of the foaming section 122 is adjusted. The temperature detectors 124 are connected to the pre-heating section 121 and the foaming section 122. The temperature of the foaming section 122 is higher than that of the mold head 15.

A recess 321 is defined in the outer periphery of the bottom rollers 32 so as to press and roll the foam pipe 5.

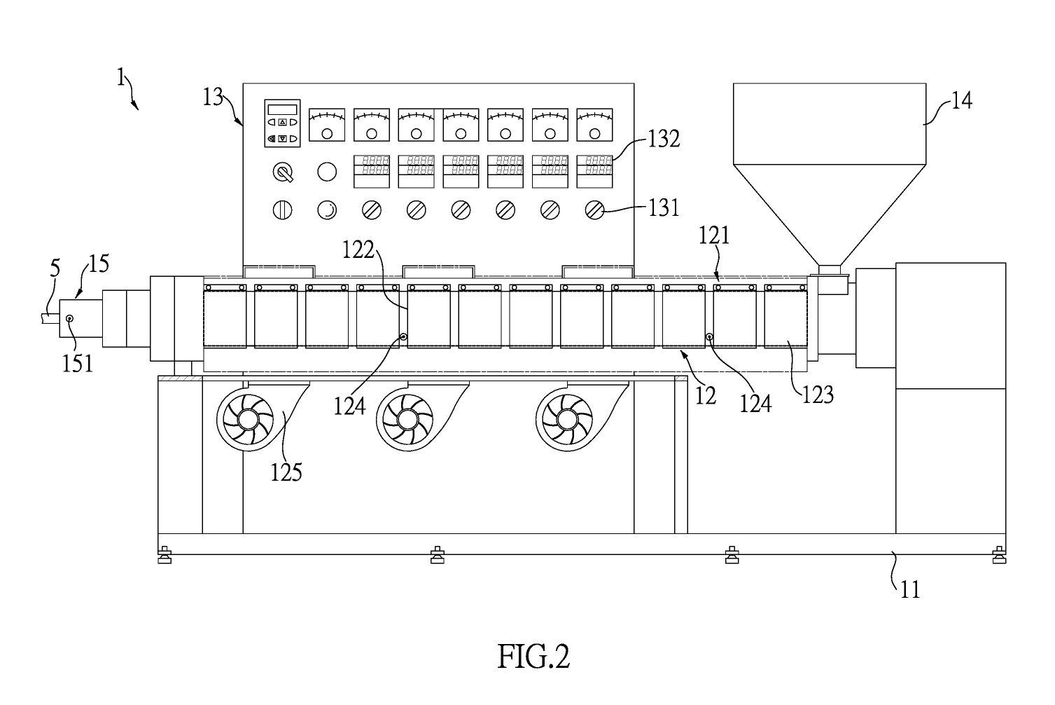

As shown in FIG. 2, the cooling tank 21 of the cooling unit 2 has multiple rollers 25 which move the foam pipe 5 from the input hole 22 toward the output hole 23. In this embodiment, there are three rollers 25.

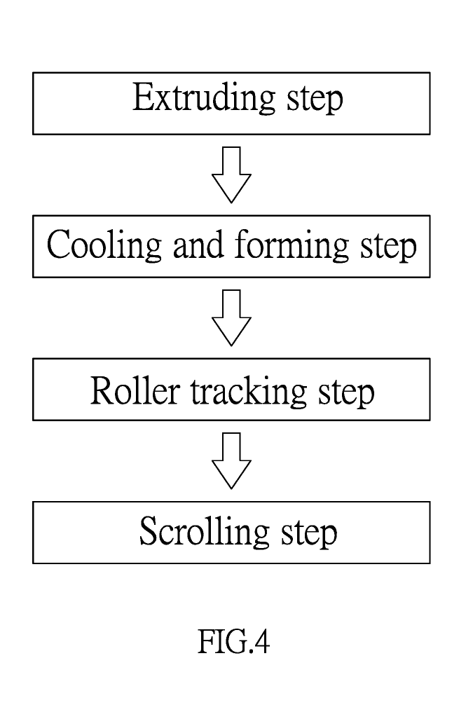

As shown in FIG. 4, the method for making the foam pipes comprises an extruding step, a cooling and forming step, a roller tracking step and a scrolling step. The extruding step includes to put foaming material and foaming agent in an input member 14 of a micro foam extruding unit 1, and the foaming material and the foaming agent are sufficiently mixed together. The foaming material is heated and melted in an extruding pipe 12 and a mold head 15 that is connected to the extruding pipe 12. The foaming agent is resolved in the melted foaming material. The mixture is extruded from the mold head 15 via the extruding pipe 12 to reduce the pressure of the mixture. The foaming agent creates micro bubbles in the mold head 15 and the foam pipe 15 includes these micro bubbles. A semi-finished foam pipe 5 with micro bubbles is extruded from the mold head 15. The foaming material is heated in the extruding pipe 12 and receiving pre-heating temperature, foaming temperature and mold head temperature in sequence. The temperature of the foaming temperature is higher than or equal to that of the mold head temperature.

The cooling and forming step includes that the semi-finished foam pipe 5 is sent into a cooling unit 2 and in contact with liquid to be cooled down.

The roller tracking step includes that the periphery of the cooled semi-finished foam pipe 5 is tracked by the top rollers 31 and the bottom rollers 32 of a roller tracker 3.

The scrolling step includes that the foam pipe 5 tracked by the top rollers 31 and the bottom rollers 32 is rolled by a scrolling unit 4.

It is noted that the temperature of the foaming temperature is higher than that of the pre-heating temperature.

The foaming material is Poly Vinyl Chloride (PVC), Ethylene Vinyl Acetate (EVA), Polyethylene (PE) or Polyurethane (PU). The foaming agent is Azodicarbonamide (ADCA), C₂H₄O₂N₄ (AC foaming agent), OBSH foaming agent, and DPT foaming agent. 0.1 to 0.6 grains of the foaming agent is used for 1 kilogram of foaming material.

While we have shown and described the embodiment in accordance with the present invention, it should be clear to those skilled in the art that further embodiments may be made without departing from the scope of the present invention.

1. A device for making foam pipes, comprising:
a micro foam extruding unit (1) having a base (11), an extruding pipe (12), a control portion (13), an input member (14) and a mold head (15), the extruding pipe (12) and the control portion (13) connected to the base (11), the input member (14) and the mold head (15) located corresponding to two ends of the extruding pipe (12), the extruding pipe (12) having a pre-heating section (121) and a foaming section (122) which is connected to the pre-heating section (121), multiple heating members (123) axially and alternatively connected to outside of each of the pre-heating section (121) and the foaming section (122) so as to transfer heat to the extruding pipe (12) to pre-heat foaming material and to reach melting temperature and foaming temperature of the foaming material, foaming agent being spread and solved in foaming material that is melted, the melted foaming material being extruded from the mold head (15) to expand micro bubbles to form a foam pipe (5) with micro bubbles, the heating members (123) being controlled by control buttons (131), multiple temperature detectors (124), (151) connected to the mold head (15), the pre-heating section (121) and the foaming section (122) to respectively transfer temperature signals to temperature gauges (132) on the control portion (13), a temperature of the foaming section (122) being higher than that of the mold head (15);
a cooling unit (2) having a cooling tank (21) which includes an input hole (22) and an output hole (23) in two ends thereof, the foam pipe (5) extending through the input hole (22) and the output hole (23) so as to enter into the cooling tank (21) and leave from the cooling tank (21), the cooling unit (2) having multiple cooling pipes (24) which extend into the cooling tank (21), the cooling pipes (24) transferring cooling liquid and contacting the foam pipe (5) to reduce temperature of the foaming pipe (5);
a roller tracker (3) having at least one top roller (31) and at least one bottom roller (32) to press the foam pipe (5) and guide the foam pipe (5), and
a scrolling unit (4) having a rotary member (41) to scroll the foam pipe (5).

2. The device for making foam pipes as claimed in claim 1, wherein a temperature of the foaming section (122) is higher than that of the pre-heating section (121).

3. The device for making foam pipes as claimed in claim 2, wherein multiple blowing members (125) are alternatively located to the base (11) and electrically connected to the control buttons (131), the blowing members (125) blow air toward the foaming section (122).

4. The device for making foam pipes as claimed in claim 3, wherein the at least one bottom roller (32) of the roller tracker (3) includes a recess (321) defined in an outer periphery thereof so as to roll the foam pipe (5).

5. The device for making foam pipes as claimed in claim 4, wherein the cooling tank (21) of the cooling unit (2) has multiple rollers (25) which move the foam pipe (5) from the input hole (22) toward the output hole (23).

6. The device for making foam pipes as claimed in claim 5, wherein the foaming material is Poly Vinyl Chloride (PVC), Ethylene Vinyl Acetate (EVA), Polyethylene (PE) or Polyurethane (PU), the foaming agent is Azodicarbonamide (ADCA), C₂H₄O₂N₄ (AC foaming agent), OBSH foaming agent, DPT foaming agent, 1.0 to 6.0 grams of the foaming agent is used for 1 kilogram of foaming material.

7. A method for making the foam pipes, comprising:
an extruding step: foaming material and foaming agent being put in an input member (14) of a micro foam extruding unit (1) and being extruded from an extruding pipe (12), the foaming material being heated and melted in the extruding pipe (12) and a mold head (15) that is connected to the extruding pipe (12), the foaming agent being resolved in the melted foaming material, a semi-finished foam pipe (5) with micro bubbles being extruded from the mold head (15), the foaming material being heated in the extruding pipe (12) and receiving pre-heating temperature, foaming temperature and mold head temperature in sequence, a temperature of the foaming temperature being higher than or equal to that of the mold head temperature;
a cooling and forming step: the semi-finished foam pipe (5) being sent into a cooling unit (2) and in contact with liquid to be cooled down;
a roller tracking step: a periphery of the cooled semi-finished foam pipe (5) being tracked by a top roller (31) and a bottom roller (32) of a roller tracker (3), and
a scrolling step: the foam pipe (5) tracked by the top roller (31) and the bottom roller (32) being rolled by a scrolling unit 4.

8. The method as claimed in claim 7, wherein the foaming material is Poly Vinyl Chloride (PVC), Ethylene Vinyl Acetate (EVA), Polyethylene (PE) or Polyurethane (PU), the foaming agent is Azodicarbonamide (ADCA), C₂H₄O₂N₄ (AC foaming agent), OBSH foaming agent, and DPT foaming agent, 1.0 to 6.0 grams of the foaming agent is used for 1 kilogram of foaming material.

9. The method as claimed in claim 8, wherein the temperature of the foaming temperature is higher than that of the pre-heating temperature.
